(19) United States
(12) Patent Application Publication
(10) Pub. No.: US 2007/0078199 A1
(43) Pub. Date: Apr. 5, 2007

(54) Color pigment inks for general use

(76) Inventors: Meagan Catherine Winkler, Lexington, KY (US); Sandra Helton McCain, Lexington, KY (US); Paul Sacoto, Lexington, KY (US); Jamee Casteel Holiway, Shelbyville, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/393,241

(22) Filed: Mar. 30, 2006

Related U.S. Application Data
(63) Continuation-in-part of application No. 10/782,227, filed on Feb. 19, 2004, now abandoned.

(51) Int. Cl. C09D 11/00

(52) U.S. Cl. 523/160

(57) ABSTRACT

Thermal inkjet inks having at least about 5 percent by weight pigment, a dispersant having moieties of methacrylic acid, poly(propylene glycol)-4-nonylphenyl ether acrylate and poly(ethylene glycol) 2,4,6-tris-(1-phenylethyl)phenyl)ether methacrylate; a humectant and a surfactant, preferably ethoxylated 2,4,7,9-tetramethyl 5 decyn-4,7-diol.

### CROSS REFERENCE TO RELATED APPLICATION

This is a continuation-in-part to application Ser. No. 10/782,227 filed on Feb. 19, 2004 with the same title as this application.

### TECHNICAL FIELD

This invention relates to liquid inks for thermal printing on paper or for other general purpose use.

### BACKGROUND OF THE INVENTION

Commonly used colorants in ink compositions of ink jet printers are dyes. Aqueous based inks containing dyes tend to have excellent stability through life, vibrant color and excellent jettability. The disadvantage of using dyes is their inability to be light and water resistant.

Inkjet printer inks for general use preferably should print realistic color photographs of archive endurance. The utilization of pigments as colorants has become a desired alternative to dyes because of their excellent light, air and water resistance on a wide range of medias.

The difference in lightfastness of dyes and pigments results from their structures. Dyes are soluble organic colorants with weak intermolecular forces that easily dissolve in solvents. Pigments are insoluble organic colorants with strong intermolecular forces. Dyes are single molecules with large surface areas that have little resistance to the harsh fading effects of ozone and sunlight. Pigmented inks have excellent archivability compared to dyes because each pigment particle contains many molecules resulting in only a small portion of the pigment's molecules being exposed to light and air components.

Unfortunately, the morphology and water solubility of typical pigment particles causes them to be more difficult than dyes to jet and maintain in a high resolution thermal printhead. In addition the majority of the chromophores of a pigment particle are not at the surface, and therefore the color intensity of pigment ink is lower than dye ink.

This invention describes a pigmented inkjet ink set with good color that provides excellent light and water resistance while maintaining excellent jettability in a high resolution, 4 nanogram (ng) drop mass printhead. In addition, this ink composition contains a humectant set designed to produce images with minimal paper curl.

### DISCLOSURE OF THE INVENTION

To improve the color strength (intensity) of color pigments, the pigment loads for cyan, magenta and yellow are 5% or greater by weight of the weight of the ink. The pigment loads for the magenta and yellow are preferably 6% or greater by weight of the ink. The dispersant for magenta, yellow and cyan contains less than 9:1 by mole methacrylic acid to poly(propylene glycol)-4-nonylphenyl ether acrylate (NPHPPG), and at least 5 mole percent of poly (ethylene glycol) 2,4,6-tris-(1-phenylethyl)phenyl ether methacrylate (TRISA), and is of about 2,500 to 15,000 number average molecular weight. Preferably, the molar ratio of TRISA in the dispersant is from about 1 part to about 7 parts of the methacrylic acid and NPHPPG combined. The cyan, magenta and yellow inks have a pigment to dispersant ratio greater than 2.5:1 by weight and less than about 9.5:1. The inks include at least one pigment colorant having a multiple aromatic ring structure, at least one dispersant, at least 20 weight % of co-solvents such as high boiling point, water soluble organic agents and a nonionic surfactant comprising hydrophobic and hydrophilic segments.

Acrylic acid and lower alkyl substituted acrylic acids are alternatives in the dispersants for methacrylic acid. Collectively, those acids will be given the short designation (MAA).

The range of monomer molar composition defining alternate random polymeric disperants in accordance with this invention are MAA 45-90%; NPHPPG 5-20% and TRISA 5-20%.

The ink set of the present invention provides jet printing inks that produce high quality prints and good jetting when using reduced mass droplets of ink jetted from small diameter (4 ng drops) nozzles at high frequencies. Each ink composition includes a pigment colorant, a dispersant, one or more co-solvents, a surfactant and a biocide.

### DESCRIPTION OF THE PREFERRED EMBODIMENTS

Colorants in the present invention include Pigment Blue 15:4, Pigment Red 122 and Pigments Yellow 155 and Yellow 74. As is widely true for color pigments, these pigments have multiple aromatic rings. These pigments are resistant to light fading (good light fastness), as are most pigments. The amount of colorant in conventional pigment ink composition may be varied depending on a number of factors, but the colorant is commonly present in an amount of from between about 1 to about 10% by weight, and more preferably from about 3 to about 7% by weight (based on total weight of the ink).

Each pigment is dispersed using a dispersant chosen to maximize color, function and stability. The basic chemical content and molecular structure of the dispersant is consistent with subject matter of U.S. Pat. No. 6,652,634 B1, to Akers, Jr. et al., assigned to the assignee of this invention. This invention further defines the dispersant form and use in terms of molecular size, hydrophobic content, and total dispersant content in order to improve color strength.

Data with respect to the dispersant was collected from a designed experiment that included 30 trials, 4 factors and several effects consisting of functional and print quality attributes. The 4 factors included are as follows:
1. Pigment load in the ink.
2. Hydrophobic monomer composition in the dispersant poly(propylene glycol)-4-nonylphenyl)ether acrylate (NPHPPG).
3. Amount of chain transfer agent in the dispersant, which is inversely proportional to the molecular weight of the dispersant.
4. Pigment to dispersant ratio which is inversely proportional to the amount of dispersant in the ink.

Increasing the following factors increases the color strength of the ink: 1) pigment load, 2) the amount of hydrophobic monomers in the dispersant molecule, 3) the number average molecular weight of the dispersant molecule, 4) pigment to dispersant ratio by weight. Desirable pigment loads for cyan, magenta and yellow are 5% or greater by weight of the ink. The pigment loads for the magenta and yellow are preferably 6% or greater by weight of the ink. Also, the dispersant for magenta and yellow contain less than 9:1 methacrylic acid to NPHPPG by mole, at least 5 mole % TRISA, and a pigment:dispersant ratio greater than 2.5:1 by weight.

It is known in this industry that humectants (also termed cosolvents) are added to the ink composition to aid in maintaining the colorant in solution and to enhance the ink performance. Additional development work has determined which cosolvents reduce paper curl in addition to maintaining printhead function.

In order to reduce paper curl it is imperative to understand the mechanism and determine the ink components that have an effect on curl. Media tends to curl after a large quantity of ink is deposited onto the surface of the printing substrate. Plain-paper substrates are comprised mainly of cellulose fibers, along with varying levels of inorganic fillers. It is the interaction of the water in the inkjet inks with these cellulose fibers that leads to the phenomenon of paper curl. The absorption of water by the cellulose fibers causes breaking of the interfiber bonds.

Upon drying there are differential stresses between the printed and non-printed surfaces. These differential stresses manifest themselves as paper curl, whereby the substrate tends to curl towards the surface from which moisture was last removed (the imaged surface). An ink formulation with a reduced level of water in addition to humectants with high boiling points effectively eliminates the typical end-user problems of stacking and displaying printed images with unacceptable levels of curl.

The present invention uses SURFYNOL 465, an acetylene glycol compound represented by ethoxylated 2,4,7,9-tetramethyl 5 decyn-4,7-diol. This material acts to reduce the surface tension of the ink so that a more uniform surface energy on the surface of the nozzle plate is achieved. This action has been observed to minimize puddling of the ink on the surface of the nozzle plate. Additionally, the surfactant is a low foaming material that has a high cloud point that helps reduce bubble formation from the dissolved gases in the ink at the high temperatures encountered by the ink in the firing chambers.

Biocides, such as for example, Kordek MLX, sold commercially by Rohm and Haas, may be added to the ink to prevent or inhibit growth of microorganisms in the ink. Generally, the addition of from about 0.01 to about 0.2% by weight of a biocide will be effective in reducing the gram positive and negative bacteria as well as mold growth.

The following in Table 1 are formulations for thermal, inkjet inks in accordance with this invention.

| | Pigment | Pigment Red | Pigment |
|---|---|---|---|
| | Blue 15:4 | 122 | Yellow |
| Pigment | 5 | 6 | 6.5** |
| Pigment to Dispersant ratio¹ | 3:1 | 2.83:1 | 3.53:1 |
| Dispersant Monomer ratio | 6.3:1:1 | 6.3:1:1 | 6.3:1:1 |
| MAA:NPHPPG:TRISA² | | | |
| Dispersant Moleculer Weight Mn* | 7,975 | 7,975 | 7,975 |
| Dispersant Mole % Chain Transfer | 6 | 6 | 6 |
| Agent³ | | | |
| Glycerol | 10 | 6 | 6 |
| Triethylene Glycol | 4.25 | 12 | 12 |
| Polyethylene glycol MW 200 | | 2.5 | 2.5 |
| Tripropylene Glycol | 6 | | |
| KORDEK MLX | 0.15 | 0.15 | 0.15 |
| SURFYNOL 465 | 0.75 | 0.7 | 0.7 |
| DI Water | Balance | Balance | Balance |

**6.5 Yellow Pigment includes 5.5 Yellow 155 and 1 Yellow 74
Mn* values are based on polystyrene standards
MAA = methacrylic acid
NPHPPG = poly (propylene glycol)-4-nonylphenyl ether acrylate
TRISA = Poly (ethylene glycol) 2,4,6-tris-(1-phenylethyl) phenyl ether methacrylate
¹= by weight
²= by mole, random distribution
³= dodecylmercaptan

In order to provide an ink set with high print quality, it is important to maintain the nozzles by reducing pigment flocculation and clogging. The current ink set includes a combination of high boiling point cosolvents which prevent nozzle clogging and provide low paper curl. With the correct level and combination of the cosolvents, the nozzles jet without clogging for long term jetting stability. The inks of Table 1 above used in a Lexmark printer, in 4 ng small nozzles, has a good long term jetting stability (defined as less than 2% of nozzles dropped out at the end of life printing).

Resistance to water can be judged by placing an ice cold cup of water on top of print samples printed on ordinary paper for 15 seconds and 1 hour. The samples imaged with the inks of Table 1 remain unchanged, while dye-based inks sample distort significantly.

The inks in Table 1 in response to ozone have minimal fade on all types of media, including microporous media. Dye based inks are known to have high fade on microporous media.

Increasing pigment load has an expected positive effect on color strength. This is not only because of the increase in colorant, but also probably because the increase in solid materials which would prevent colorant from advancing into the paper media.

Increasing the amount of hydrophobic monomers improves printed color density. It is believed that a dispersant with a lower hydrophilic content would have less mobility with the liquid phase upon ink drying on a paper substrate. In addition, it is expected to have less electrostatic stabilization which promotes the formation of insoluble networks which help the colorant to stay on the surface and contribute to the printed optical density.

Studies indicate that the printed color density can be improved by using dispersants with higher molecular weight. It is believed that as the ink dries in a substrate, higher molecular weight dispersants form networks easier as they would have less mobility through and about the paper fiber, thus maintaining the colorant on the paper surface and providing higher color strength. Smaller molecular weight dispersants would tend to do the opposite. They would migrate easier with the fluid through the paper surface, thus decreasing color density.

Finally, studies indicate that lower levels of dispersant amounts can yield higher density colors. This may again result from the reduced stability of the colorant particles and also from the reduced surface activity of ink media having less free dispersant.

Nevertheless, there are also negative implications to the modifications suggested. For instance, increasing the pigment load increases the solids load and ink viscosity, which has a detrimental effect in printhead function. Increased dispersant hydrophobicity also reduces the pigment dispersion stability, which has detrimental effects in concentrate processability, printhead function and ink shelf life. Reducing the amount of dispersant would have similar effects. Increasing the molecular size of the dispersant can also have negative effects in terms of jetting stability since larger dispersant molecules increase the ink viscosity.

Therefore, an optimum is reached on the basis of color strength, but without neglecting shelf life stability, printhead function and processing ability. Furthermore, the optimum dispersant/pigment load combination is unique for each pigment type. This is because each pigment chemistry, morphology and surface characteristic is different.

The four major variables for improved gamut versus hue angle are higher pigment load, higher amount of hydrophobic monomer in the dispersant, higher molecular weight of the dispersant, and lower dispersant amount. Studies show satisfactory inks having a 32% improvement in total gamut volume. Color improvements were made for yellow, magenta and cyan, where all 4 variables were optimized.

### Humectant Set

There have been two major approaches used to reduce the observed level of paper curl when printing on plain paper with the ink set of this invention.
1. To reduce the overall level of water contained within the individual inks
2. To incorporate humectants with high boiling points

The humectants have been chosen to include hydroxyl groups and other polar functional groups that are highly compatible with water, which are effective in reducing the evaporation rate of water, and are also capable of bonding to the cellulose fibers through hydrogen bonding. Three humectants used in this inventive ink set are summarized in Table 2.

TABLE 2

| HUMECTANT | MW (g/mol) | B.P. (° C.) |
|---|---|---|
| Glycerol | 92.09 | 287° |
| Triethylene Glycol | 150.17 | 285° |
| Poly(ethylene glycol) | 200.00 | 314° |

The humectant level of each of the three inks described in Table 1 was adjusted to achieve formulations ranging from 10% to 35% total humectants. A photographic image was then printed with each of the ink sets onto Hammermill Laser Print paper under controlled conditions of temperature (70° F.) and relative humidity (50%). Three replicates of each sample were produced, and the average curl deflection was calculated.

A significant decrease in the amount of curl is observed when increasing the humectant level from 10% to 15% and also from 15% to 20%. Increasing the humectant level beyond 20% gives you only a very slight improvement in the level of curl.

Although increasing the humectant level beyond 20% can give slight improvements in curl performance, one must also consider the adverse effects of high humectant levels on printhead performance. To address this issue each of the ink sets (humectant levels from 10%-35%) was printed to the end of its life (EOL) and the number of small nozzles missing were counted.

The reliability data exhibits an optimum range, which is also centered around a total humectant level of 20%. Low humectant levels can cause issues such as degassing phenomena along with high evaporation rates from the nozzle orifices, which can cause problems such as ink drying and clogging in the small nozzle openings. Excessively high humectant levels can cause jetting problems due to high ink viscosity and also problems associated with difficult bubble nucleation due to the high organic content (low water content).

The reduction in paper curl with increasing boiling points can be observed within any homologous series of humectants such as diols, triols, glycols, polyalkyl glycols, etc. Diethylene glycol exhibits significant curl while triethylene glycol is almost one-third less in 24 hours. High molecular weight showed much less dramatic improvement in curl.

What is claimed is:

1. A thermal inkjet ink comprising, by weight with respect to the total weight of said ink:
at least about 5 percent color pigment having aromatic rings, a dispersant having moieties consisting essentially of acrylic acid or lower alkyl substituted acrylic acid (MAA), poly(propylene glycol)-4-nonylphenyl ether acrylate (NPHPPG), and poly(ethylene glycol) 2,4,6-tris-(1-phenylethyl)phenyl ether methacrylate, (TRISA),
a pigment to dispersant ratio by weight of about 2.5 to 9.5 parts pigment to 1 part dispersant,
a humectant and
a surfactant.

2. The ink of claim 1 in which the molar ratio of said TRISA in said dispersant is about 1 part to 7 parts of said MAA and NPHPPG combined.

3. The ink of claim 1 in which said surfactant is ethoxylated 2,4,7,9-tetramethyl 5 decyn-4,7-diol.

4. The ink of claim 2 in which said surfactant is ethoxylated 2,4,7,9-tetramethyl 5 decyn-4,7-diol.

5. A thermal inkjet ink comprising, by weight with respect to the total weight of said ink:
at least about 5 percent color pigment having aromatic rings,
a dispersant having moieties consisting essentially of acrylic acid or lower alkyl substituted acrylic acid (MAA), poly(propylene glycol)-4-nonylphenyl ether acrylate (NPHPPG), and poly(ethylene glycol) 2, 4, 6-tris-(1-phenylethyl)phenyl ether methacrylate (TRISA),
the molar ratio of said MAA in said dispersant is about 6 parts to 2 parts of said NPHPPG and TRISA combined,
a pigment to dispersant ratio by weight of about 2.5 to 9.5 parts pigment to 1 part dispersant,
a humectant and
a surfactant.

6. The ink of claim 5 in which the molar ratio of said TRISA in said dispersant is about 1 part to 7 parts of said MAA and NPHPPG combined.

7. The ink of claim 5 in which said surfactant is ethoxylated 2,4,7,9-tetramethyl 5 decyn-4,7-diol.

8. The ink of claim 6 in which said surfactant is ethoxylated 2,4,7,9-tetramethyl 5 decyn-4,7-diol.

9. A thermal inkjet ink comprising, by weight with respect to the total weight of said ink:
at least about 5 percent color pigment having aromatic rings,
a dispersant having moieties consisting essentially of an acrylic acid or lower alkyl substituted acrylic acid (MAA), poly(propylene glycol)-4-nonylphenyl ether acrylate (NPHPPG), and poly(ethylene glycol) 2,4,6-tris-(1-phenylethyl)phenyl ether methacrylate (TRISA), the monomer molar composition of said dispersant being by percent 45-90 MAA, 5-20 NPHPPG, and 5-20 TRISA,
a pigment to dispersant ratio by weight of at least about 2.5 parts pigment to 1 part dispersant,
a humectant and
a surfactant.
